(19) United States
(12) Patent Application Publication
(10) Pub. No.: US 2025/0345858 A1
(43) Pub. Date: Nov. 13, 2025

(54) ADDITIVE MANUFACTURING DEVICE

(71) Applicants: Blaine Zimmer, Youngsville, LA (US); Finley Zimmer, Youngsville, LA (US)

(72) Inventors: Blaine Zimmer, Youngsville, LA (US); Finley Zimmer, Youngsville, LA (US)

(21) Appl. No.: 19/204,488

(22) Filed: May 10, 2025

Related U.S. Application Data
(60) Provisional application No. 63/645,898, filed on May 12, 2024.

(51) Int. Cl. B22F 12/41; B22F 12/00; B22F 12/30; B22F 12/52; B33Y 10/00; B33Y 30/00

(52) U.S. Cl. CPC B22F 12/41; B22F 12/30; B22F 12/38; B22F 12/52; B22F 2999/00; B33Y 10/00; B33Y 30/00

(57) ABSTRACT

Disclosed is an additive manufacturing device configured to use resistive heating to form an article from conductive metal powder, as well as methods of using the same. The additive manufacturing device dispenses successive layers of material comprising conductive metal powder and a nonconductive, heat-resistant powder, wherein the nonconductive, heat-resistant powder serves as a mold that holds and supports each layer of conductive metal powder. The conductive metal powder is then melted using resistive heating to form the article.

### CROSS-REFERENCE TO RELATED APPLICATION(S)

This application claims the benefit of U.S. Provisional Application Ser. No. 63/645,898, filed on May 12, 2024, the entirety of which is incorporated herein by reference.

### TECHNICAL FIELD

This disclosure relates to additive manufacturing devices and methods of using the same.

### BACKGROUND

Additive manufacturing, commonly referred to as 3D printing, is a process by which objects are built layer by layer from digital models. Traditional additive manufacturing technologies often rely on polymers or photopolymer resins and typically use thermal extrusion, photopolymerization, or selective laser sintering to create the desired geometry. While these methods are effective for prototyping and producing plastic components, they are less suitable for producing metal parts due to limitations in material compatibility, thermal requirements, and structural integrity.

Existing metal additive manufacturing systems frequently employ complex mechanisms such as lasers, electron beams, or binding agents to process metal powders. These approaches tend to be expensive, require high-maintenance equipment, and may pose safety concerns related to the energy sources involved. Moreover, precise control of powder placement and thermal input is often difficult to achieve, which can result in inconsistent material properties or undesirable porosity in the final part. Therefore, there remains a need for improved additive manufacturing devices and methods that enable the fabrication of metal articles using more cost-effective technologies.

Accordingly, there is a need for the additive manufacturing device disclosed herein. The present invention is directed to providing an additive manufacturing device configured to address these and other needs.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is an additive manufacturing device configured to use resistive heating to form an article from conductive metal powder, as well as methods of using the same. The additive manufacturing device dispenses successive layers of material comprising conductive metal powder and a nonconductive, heat-resistant powder, wherein the nonconductive, heat-resistant powder serves as a mold that holds and supports each layer of conductive metal powder. The conductive metal powder is then melted using resistive heating to form the article.

An example additive manufacturing device comprises a build tank having at least one sidewall formed from an electrically nonconductive and heat-resistant material, the sidewall having a plurality of electrical contacts positioned flush or substantially flush with an interior surface thereof; a vertically movable build platform positioned within the build tank, the build platform comprising an electrically conductive build surface; at least one powder dispenser assembly movably positioned above the build platform, the powder dispenser assembly comprising: a first powder hopper for conductive metal powder; a second powder hopper for nonconductive and heat-resistant powder; and an array of nozzles configured to dispense one or more layers of conductive metal powder and nonconductive, heat-resistant powder onto the electrically conductive build surface; and an electrical power source operatively connected to the plurality of electrical contacts and configured to selectively pass electrical current through the dispensed conductive metal powder to generate resistive heating sufficient to melt and fuse the conductive metal powder into an article.

An example method of forming an article using additive manufacturing comprises dispensing successive layers of material onto an electrically conductive build surface positioned within a build tank, each layer comprising a conductive metal powder and a nonconductive, heat-resistant powder, the nonconductive, heat-resistant powder forming a mold for the conductive metal powder, with at least a portion of the conductive metal powder forming the article; electrically connecting the conductive metal powder forming the article to at least one electrical contact positioned flush or substantially flush with an interior side of at least one sidewall of the build tank; and passing electrical current through the conductive metal powder to generate resistive heating sufficient to melt and fuse the conductive metal powder into the article.

### BRIEF DESCRIPTION OF THE DRAWINGS

FIG. 1 is a perspective view of an additive manufacturing device, in accordance with the principles of the present disclosure.

FIG. 2 is a cutaway view of the additive manufacturing device of FIG. 1.

FIG. 3 is another cutaway view of the additive manufacturing device of FIG. 1, illustrating an article being fabricated.

FIG. 4 is a block diagram illustrating various components of the additive manufacturing device of FIG. 1, including additional components described in the present disclosure that are not otherwise illustrated.

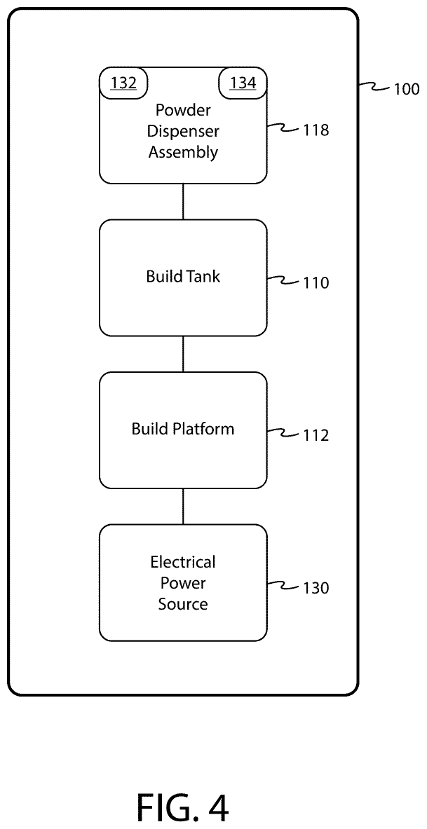

FIG. 5 is a flowchart illustrating a method of fabricating an article using additive manufacturing in accordance with the principles of the present disclosure.

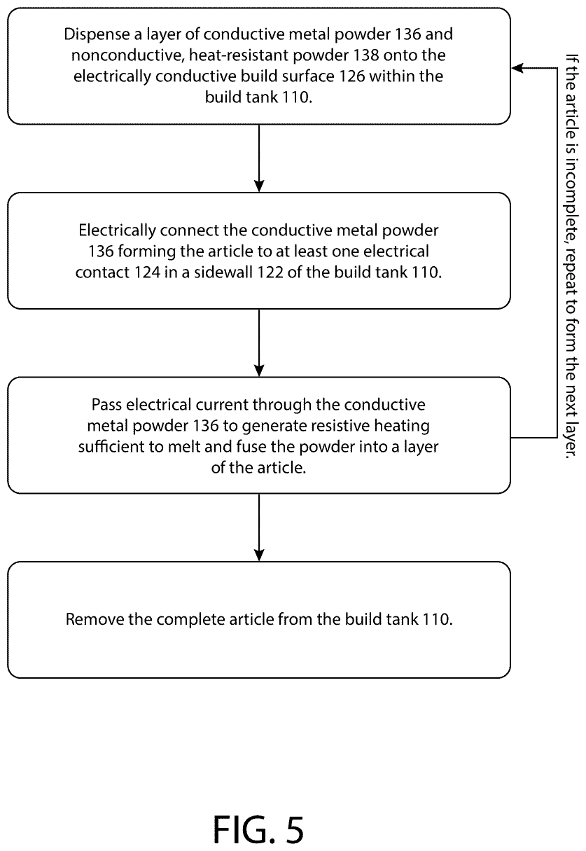

Like reference numerals refer to corresponding parts throughout the several views of the drawings.

### DETAILED DESCRIPTION

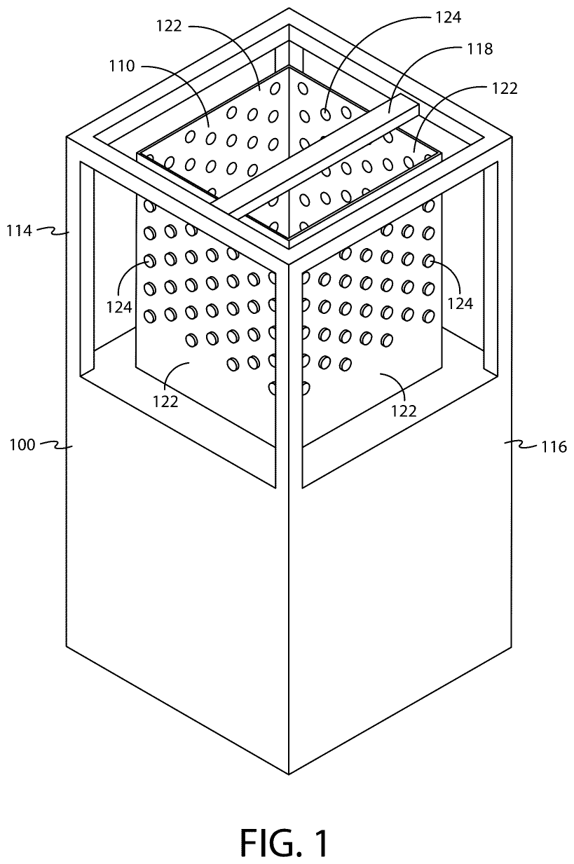

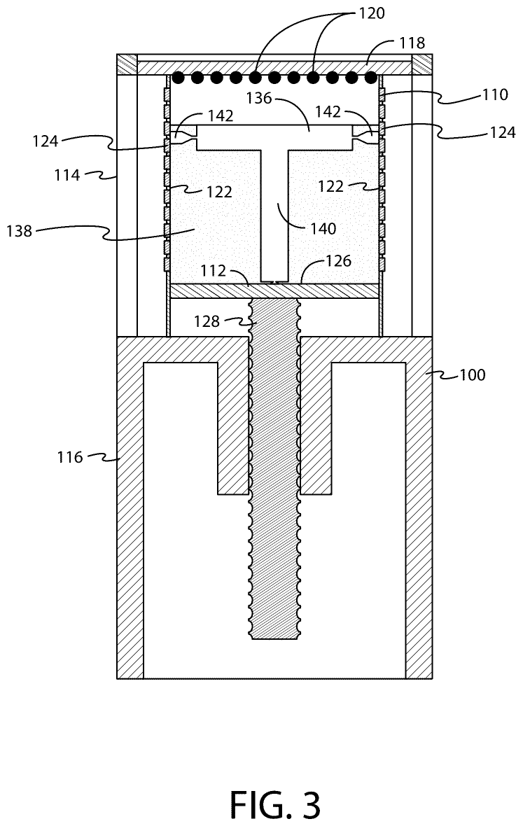

FIGS. 1-3 illustrate an additive manufacturing device 100 according to the principles of the present disclosure. The additive manufacturing device 100 uses resistive heating to form an article, such as the T-shaped article 140 shown in FIG. 3, from conductive metal powder 136. Specifically, the additive manufacturing device 100 dispenses successive layers of material comprising conductive metal powder 136 and a nonconductive, heat-resistant powder 138, wherein the nonconductive, heat-resistant powder 138 serves as a mold that holds and supports each layer of conductive metal powder 136. The additive manufacturing device 100 then melts the conductive metal powder 136 using resistive heating to form the article.

As shown in FIGS. 1-3, the additive manufacturing device 100 comprises a build tank 110, a build platform 112, a structural frame 114, a base 116, and at least one powder dispenser assembly 118.

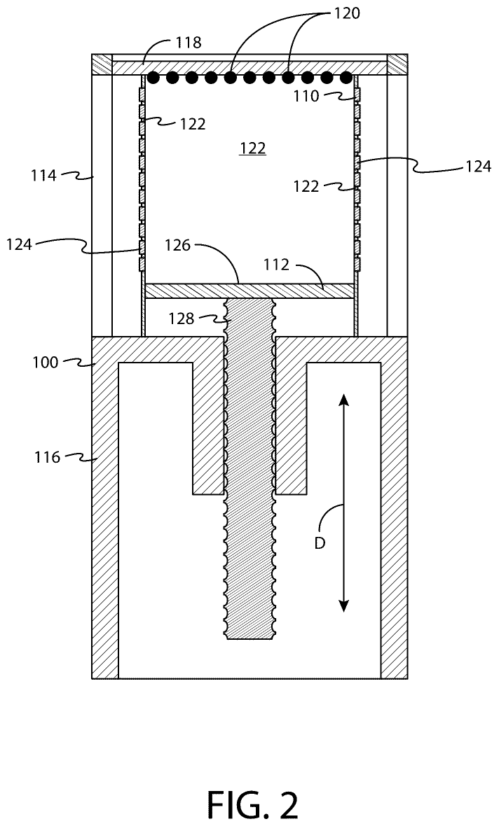

The build tank 110, generally rectangular in shape as shown, is mounted to the base 116. The structural frame 114, also mounted to the base 116, provides rigid support and positions the powder dispenser assembly 118 above the build tank 110. The powder dispenser assembly 118 includes an array of nozzles 120, each configured to deposit a predetermined amount of powdered material onto the build platform 112. The build platform 112, positioned within the build tank 110, is configured to move vertically upward and downward, as indicated by arrow D seen in FIG. 2.

The build tank 110 comprises four sidewalls 122, each formed from an electrically nonconductive and heat-resistant material, such as carbon fiber or a metal alloy coated with rubber to inhibit electrical conduction. As used herein, “heat-resistant” refers to a material having a melting point higher than that of the conductive metal powder 136 used to fabricate the article. Each sidewall 122 includes an array of electrical contacts 124, each formed from an electrically conductive material. In some implementations, each of the electrical contacts 124 may be plated with a corrosion-resistant material, such as nickel. Each electrical contact 124 is nested within an opening in the sidewall 122 and sits flush, or substantially flush, with the interior surface of the sidewall 122 to facilitate contact with the conductive metal powder 136 and to allow the build platform 112 to vertically move relative to the sidewall 122. The contacts 124 may be press-fit, bonded, or retained using a dielectric sleeve to insulate them from the surrounding material of the sidewall 122. The electrical contacts 124 are operatively connected to an electrical power source 130 via high-temperature wiring or conductive traces. The power source 130 provides direct current (DC) or alternating current (AC) at selectable voltages and currents suitable for generating resistive heating and melting the conductive metal powder 136.

The build platform 112 has a build surface 126. The build surface 126 is electrically conductive and faces the powder dispenser assembly 118. The build surface 126, or at least the portion thereof on which a first layer of conductive metal powder 136 rests, is operatively connected to the electrical power source 130 via high-temperature wiring or conductive traces. Vertical movement of the build platform 112 is controlled by a drive assembly, such as a stepper motor, operably connected to a mechanical component, such as a lead screw 128, attached to the underside of the build platform 112. One of ordinary skill in the art, having the benefit of the present disclosure, would be able to select a suitable drive assembly. The drive assembly, in conjunction with the lead screw 128, is configured to provide for incremental vertical movement of the build platform 112.

The powder dispenser assembly 118 is configured to move side-to-side over the build platform 112 within the build tank 110, with the structural frame 114 acting as a gantry. The array of nozzles 120 is in fluid communication with at least two powder hoppers 132, 134, each containing a different powdered material that is dispensed onto the build surface 126 of the build platform 112. One powder hopper 132 contains a nonconductive, heat-resistant powder 138, such as silica or ceramic, to provide structural support and serve as a mold. As used herein, “heat-resistant” refers to a nonconductive powder having a melting point higher than that of the conductive metal powder 136 used to fabricate the article. The other powder hopper 134 contains a conductive metal powder 136, such as copper or aluminum. Alternatively, the conductive metal powder 136 may be another pure metal or metal alloy. The particle size of the conductive metal powder 136 may be selected based on the selected material, the geometry of the article being fabricated, and the ability of the material to melt via resistive heating.

### Operation and Use

During a fabrication cycle, the build platform 112 is lowered successively relative to the powder dispenser assembly 118 as previously described. Based on the shape of the article being fabricated, which is typically defined by computerized instructions, such as CAD data processed by a computerized controller (not shown), the array of nozzles 120 dispenses a layer of material comprising conductive metal powder 136 and nonconductive, heat-resistant powder 138. For each layer of material deposited on the build platform 112, the nonconductive and heat-resistant powder 138 fills the remaining space adjacent to each layer of conductive metal powder 136, acting as a mold to support the article being fabricated. In this way, each successive layer of conductive metal powder 136 is held in position by the nonconductive, heat-resistant powder 138. Additionally, in some instances, one or more bridges 142 of conductive metal powder 136 may be laid between the article being fabricated (e.g., the T-shaped article 140 shown in FIG. 3) and a corresponding number of electrical contacts 124 within the build tank 110. These conductive bridges 142 are configured to electrically connect the conductive metal powder 136 used to fabricate the article to at least one electrical contact 124, where, due to the shape and/or size of the article, the conductive metal powder 136 would not otherwise directly contact that electrical contact 124 in the sidewall 122. This allows the fabrication of the article using the additive manufacturing device 100. To fuse the layers of conductive metal powder 136 together and form an article, the conductive metal powder 136 is melted using resistive heating. Any excess material or conductive bridges 142 can be subsequently removed from the article.

The additive manufacturing device 100 fuses the conductive metal powder 136 by passing electrical current through the conductive metal powder 136 via activation of one or more electrical contacts 124 of the build tank 110 and the build surface 126 of the build platform 112. The electrical current passing through the conductive metal powder 136 generates heat due to the electrical resistance of the metal particles. This heat is sufficient to raise the temperature of the conductive metal powder 136 to its melting point, causing the metal powder particles to fuse together and form a solid layer. This process may occur after each layer of material is dispensed by the powder dispenser assembly 118 or at a later stage of the fabrication process.

Although not shown, in some implementations, the additive manufacturing device 100 may include one or more nozzles configured to remove the nonconductive, heat-resistant powder 138 after an article has been fabricated. These nozzles may be positioned within the sidewalls 122, near the top of the build tank 110, or at any other suitable location.

While the illustrated build tank 110 is generally rectangular in shape, it should be understood that the build tank 110 may alternatively have a different shape, such as a cylindrical shape. In such an implementation, the build tank 110 may comprise a single cylindrical sidewall, and the build platform 112 may have a corresponding circular shape.

Although not shown in the drawings, it should be understood that suitable wiring and/or conductive traces are provided to electrically connect one or more components of the additive manufacturing device 100, such as the electrical contacts 124, the build surface 126, and the power source 130.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. An additive manufacturing device comprising:
a build tank having at least one sidewall formed from an electrically nonconductive and heat-resistant material, the sidewall having a plurality of electrical contacts positioned flush or substantially flush with an interior surface thereof;
a vertically movable build platform positioned within the build tank, the build platform comprising an electrically conductive build surface;
at least one powder dispenser assembly movably positioned above the build platform, the powder dispenser assembly comprising: a first powder hopper for conductive metal powder; a second powder hopper for nonconductive and heat-resistant powder; and an array of nozzles configured to dispense one or more layers of conductive metal powder and nonconductive, heat-resistant powder onto the electrically conductive build surface; and
an electrical power source operatively connected to the plurality of electrical contacts and configured to selectively pass electrical current through the dispensed conductive metal powder to generate resistive heating sufficient to melt and fuse the conductive metal powder into an article.

2. The additive manufacturing device of claim 1, wherein the electrical power source is further operatively connected to the electrically conductive build surface.

3. A method of forming an article using additive manufacturing, comprising:
dispensing successive layers of material onto an electrically conductive build surface positioned within a build tank, each layer comprising a conductive metal powder and a nonconductive, heat-resistant powder, the nonconductive, heat-resistant powder forming a mold for the conductive metal powder, with at least a portion of the conductive metal powder forming the article;
electrically connecting the conductive metal powder forming the article to at least one electrical contact positioned flush or substantially flush with an interior side of at least one sidewall of the build tank; and
passing electrical current through the conductive metal powder to generate resistive heating sufficient to melt and fuse the conductive metal powder into the article.

4. The method of claim 3, further comprising forming at least one conductive bridge from conductive metal powder, the conductive bridge extending between the article being fabricated and at least one electrical contact to electrically connect the article to at least one electrical contact, thereby allowing resistive heating and fusion of the conductive metal powder by passing electrical current therethrough.
